(19) United States
(12) Patent Application Publication
(10) Pub. No.: US 2012/0251844 A1
(43) Pub. Date: Oct. 4, 2012

(54) MAGNETIC RECORDING POWDER AND METHOD OF MANUFACTURING THE SAME, AND MAGNETIC RECORDING MEDIUM

(75) Inventors: Nobuo YAMAZAKI, Minami-ashigara-shi (JP); Toshio TADA, Minami-ashigara-shi (JP); Hiroyuki SUZUKI, Minami-ashigara-shi (JP)

(73) Assignee: FUJIFILM CORPORATION, Tokyo (JP)

(21) Appl. No.: 13/431,431

(22) Filed: Mar. 27, 2012

(30) Foreign Application Priority Data
Mar. 28, 2011 (JP) 2011-069496

(51) Int. Cl. H01F 1/20; G11B 5/706

(52) U.S. Cl. 428/800; 423/594.1; 252/62.56; 252/62.6; 252/62.62

(57) ABSTRACT

An aspect of the present invention relates to magnetic recording powder, which comprises hexagonal ferrite magnetic particles, the hexagonal ferrite magnetic particle comprising 0.5 to 5.0 atomic percent of an Fe substitution element in the form of just a divalent element per 100 atomic percent of a content of Fe and having an activation volume ranging from 1,200 to 1,800 nm³.

### CROSS-REFERENCE TO RELATED APPLICATIONS

This application claims the benefit of priority under 35 USC 119 to Japanese Patent Application No. 2011-69496 filed on Mar. 28, 2011, which is expressly incorporated herein by reference in its entirety.

### BACKGROUND OF THE INVENTION

1. Field of the Invention

The present invention relates to magnetic recording powder comprising hexagonal ferrite magnetic particles and method of manufacturing the same, and more particularly, to magnetic recording powder suitable for use as the magnetic material of a magnetic recording medium for high-density recording.

The present invention further relates to a magnetic recording medium comprising the above magnetic recording powder.

2. Discussion of the Background

Recently, ferromagnetic metal powders have come to be primarily employed in the magnetic layers of magnetic recording media for high-density recording. Ferromagnetic metal powders are comprised of acicular particles of mainly iron, and are employed in magnetic recording media for various applications in which minute particle size and high coercive force are required for high-density recording.

With the increase in the quantity of information being recorded, magnetic recording media are required to achieve ever higher recording densities. However, in improving the ferromagnetic metal powder to achieve higher density recording, limits have begun to appear. By contrast, hexagonal ferrite magnetic powders have a coercive force that is high enough for use in permanently magnetic materials. Magnetic anisotropy, which is the basis of coercive force, derives from a crystalline structure. Thus, high coercive force can be maintained even when the particle size is reduced. Further, magnetic recording media employing hexagonal ferrite magnetic powder in the magnetic layers thereof can afford good high-density characteristics due to their vertical components. Thus, hexagonal ferrite magnetic powder is an optimal ferromagnetic material for achieving high density.

In recent years, various hexagonal ferrite magnetic particles having good characteristics such as those set forth above have been studied. In this regard, reference can be made to, for example, Reference 1 (Japanese Unexamined Patent Publication (KOKAI) Heisei No. 9-232123), Reference 2 (Japanese Unexamined Patent Publication (KOKAI) Heisei No. 6-077036), Reference 3 (Japanese Unexamined Patent Publication (KOKOKU) Showa No. 63-53134), Reference 4 (Japanese Unexamined Patent Publication (KOKAI) No. 2010-282671) or English language family member US 2010/304187A1, Reference 5 (Japanese Unexamined Patent Publication (KOKAI) Heisei No. 9-115715), Reference 6 (Japanese Unexamined Patent Publication (KOKAI) No. 2002-334803), and Reference 7 (Japanese Unexamined Patent Publication (KOKAI) Showa No. 62-176918,) which are expressly incorporated herein by reference in their entirety.

In recent years, higher recording densities have been achieved. Recording densities in the form of surface recording densities of 1 Gbpsi and higher, even 10 Gbpsi and higher, are being targeted. As described in Reference 7, the trend in magnetic recording powders is toward microparticles. To achieve such high-density recording, it is required to further reduce the size of hexagonal ferrite magnetic particles to reduce noise.

However, when the size of hexagonal ferrite magnetic particles is reduced, the energy maintaining the magnetic particles in the direction of magnetization (magnetic energy) tends to be difficult to resist thermal energy. So-called thermal fluctuation ends up causing recording retention property to drop, and the phenomenon whereby magnetic energy is overcome by thermal energy and recording is lost can no longer be ignored. This point will be described in greater detail. “KuV/kT” is a known index relating to the thermal stability of magnetization. Ku is the anisotropy constant of a magnetic material, V is the particle volume (activation volume), k is the Boltzmann constant, and T is absolute temperature. When the magnetic energy KuV is increased relative to the thermal energy kT, it is possible to inhibit the effect of thermal fluctuation. However, the particle diameter V, that is, the particle size of the magnetic material, should be kept low to reduce the noise of the medium, as set forth above. Since the magnetic energy is the product of Ku and V, as stated above, it suffices to increase Ku to increase the magnetic energy when V is in the low range. However, the relation HK=2 Ku/Ms exists between Ku and the anisotropy field HK. When Ku is increased without a change in Ms, HK also increases. The anisotropy field HK is a magnetic field intensity that is necessary to achieve saturation magnetization from the direction of the hard axis of magnetization. When HK is high, the reversal of magnetization by the magnetic head tends not to occur, recording (the writing of information) becomes difficult, and the reproduction output ends up dropping. That is, the higher the Ku of the magnetic particle, the more difficult it is to write information.

As set forth above, it is extremely difficult to satisfy all three characteristics of higher density recording, thermal stability, and ease of writing. This is known as the trilemma of magnetic recording. It will be a major problem in achieving higher density recording in the future. Despite various studies of hexagonal ferrite magnetic particles that are being conducted as set forth above, no hexagonal ferrite magnetic particle that solves this problem has yet been found.

### SUMMARY OF THE INVENTION

An aspect of the present invention provides for a means of resolving the trilemma of magnetic recording.

To resolve the trilemma, the present inventors conducted extensive research into discovering a means of achieving both thermal stability and ease of writing with microparticulate hexagonal ferrite magnetic particles with an activation volume V of 1,200 to 1,800 nm³ for high density recording. As a result, they determined that it was possible to inhibit demagnetization due to thermal fluctuation by employing a prescribed quantity of just divalent elements as substitution elements for Fe in microparticulate (having an activation volume V of 1,200 to 1,800 nm³) hexagonal ferrite magnetic particles capable of exhibiting a high SNR. By this means, it was possible to increase the thermal stability without increasing anisotropy constant Ku. Thus, it was possible to ensure thermal stability and high-density recording while ensuring ease of writing. This means will be described in greater detail below.

Pure M-type hexagonal ferrite is denoted by AO.6Fe₂O₃ (where A denotes Ba, Sr, or the like). In the magnetic powder employed in magnetic recording, a portion of the Fe is normally replaced with other elements to lower anisotropy constant Ku and thus ensure suitability to recording with a magnetic head (ease of writing). The Fe in AO.6Fe₂O₃ is trivalent. Normally, the Fe is replaced with a combination of divalent, tetravalent, pentavalent, and hexavalent elements and the like to achieve trivalence. This is referred to as valence compensation, and is utilized in the methods described in above References 1 to 3 and 5.

By contrast, the present inventors discovered that demagnetization due to thermal fluctuation could be inhibited by exclusive substitution with divalent elements, as stated above. However, replacing Fe with just divalent elements does not take valence compensation into account. Additionally, hexagonal ferrite magnetic particles in which valence compensation is not conducted is described in References 4 and 6. However, as indicated in Examples described further below, when substitution was conducted by valence compensation with divalent and pentavalent elements, and when exclusive substitution was made with pentavalent elements as described in Reference 4, an identical effect was not achieved. Accordingly, the effect is not manifested by “the presence of divalent elements” or “not conducting valence compensation.” Only when “exclusive Fe substitution with a prescribed quantity of divalent elements” is conducted does it become possible to inhibit demagnetization due to thermal fluctuation. This point was discovered as a result of considerable trial and error by the present inventors. The present invention was devised on the basis of this knowledge.

An aspect of the present invention relates to magnetic recording powder, which comprises hexagonal ferrite magnetic particles, the hexagonal ferrite magnetic particle comprising 0.5 to 5.0 atomic percent of an Fe substitution element in the form of just a divalent element per 100 atomic percent of a content of Fe and having an activation volume ranging from 1,200 to 1,800 nm³.

The divalent element may be selected from the group consisting of Co, Zn, Ni, and Cu.

The divalent element may comprise Zn.

The divalent element may be just Zn.

The magnetic recording powder may have thermal stability in the form of a coercive force fluctuation calculated from equation (1) below being equal to or lower than 35.0% over a range of −190° C. to +25° C.:

Coercive force fluctuation (%)=(1−(coercive force at +25° C.)/(coercive force at −190° C.))×100 (1).

A further aspect of the present invention relates to a method of manufacturing magnetic recording powder, which comprises:

conducting a glass crystallization method employing a mixture of starting materials comprising just a divalent element component as an Fe substitution component in which the divalent element content ranges from 0.5 to 5.0 atomic percent relative to 100 atomic percent of a content of Fe to yield the above magnetic recording powder.

The divalent element component may be an oxide of a divalent element selected from the group consisting of Co, Zn, Ni, and Cu.

The divalent element component may comprise an oxide of Zn.

The divalent element component may be just an oxide of Zn.

A still further aspect of the present invention relates to a magnetic recording medium comprising a magnetic layer containing ferromagnetic powder and a binder on a nonmagnetic support, wherein the ferromagnetic powder is the above magnetic recording powder.

The present invention can resolve the trilemma of magnetic recording and thus makes it possible to achieve even higher recording densities.

### BRIEF DESCRIPTION OF THE DRAWINGS

The present invention will be described in the following text by the exemplary, non-limiting embodiments shown in the figure, wherein:

FIG. 1 is a descriptive drawing (triangular phase diagram) showing an example of the composition of the starting material mixture.

FIG. 2 shows the effects of substitution elements on Hc temperature dependence.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

The present invention relates to magnetic recording powder, which comprises hexagonal ferrite magnetic particles, the hexagonal ferrite magnetic particle comprising 0.5 to 5.0 atomic percent of an Fe substitution element in the form of just a divalent element per 100 atomic percent of a content of Fe and having an activation volume ranging from 1,200 to 1,800 nm³.

The hexagonal barium ferrite magnetic particle (referred to simply as a “magnetic particle”, hereinafter) constituting the magnetic recording powder of the present invention is a microparticulate magnetic particle capable of exhibiting a high SNR and achieving both thermal stability and recording suitability. Accordingly, the magnetic recording powder of the present invention is suitable as a magnetic material in a magnetic recording medium for high-density recording.

The composition formula of pure barium ferrite is BaO.6Fe₂O₃, and is comprised of the three elements of Ba, Fe, and O, which make up the ferrite composition. By contrast, the magnetic particles constituting the magnetic recording powder of the present invention contain 0.5 to 5.0 atomic percent of just a divalent element as an Fe substitution element per 100 atomic percent of the Fe content in addition to the Ba, Fe, and O that make up the ferrite composition. The Fe in the magnetic recording powder of the present invention is exclusively substituted with a divalent element. In this context, the “exclusive substitution” in the present invention does not exclude the presence of impurities that are unintentionally incorporated in the course of actively introducing just divalent elements as Fe substitution elements in a range that can be deemed essentially exclusive. According to the present invention, in the microparticulate (with an activation volume V of 1,200 to 1,800 nm³) hexagonal ferrite magnetic particles substituted exclusively with a prescribed quantity of divalent elements, the thermal stability can be increased independently of any increase in anisotropy constant Ku. As indicated in Examples described further below, exclusive substitution with a prescribed quantity of divalent elements can markedly raise the thermal stability of the coercive force (the resistance to changes in temperature). Thus, the present inventors presumed that increasing the thermal stability of the magnetic characteristics by the exclusive substitution with a prescribed quantity of divalent elements might contribute to inhibiting demagnetization due to thermal fluctuation.

The magnetic recording powder of the present invention will be described in greater detail below.

The hexagonal ferrite magnetic particles constituting the magnetic recording powder of the present invention contain 0.5 to 5.0 atomic percent of just a divalent element as an Fe substitution element per 100 atomic percent of the Fe content. When elements of other valences (such as pentavalent elements) are present as substitution elements of Fe, it is difficult to inhibit demagnetization due to thermal fluctuation without an increase in anisotropy constant Ku. Thus, divalent elements are exclusively employed as Fe substitution elements in the present invention. The divalent elements need only be divalent elements that can be imparted with a divalent positive charge; multiple divalent elements can be employed so long as they are divalent elements. From the perspective of further enhancing thermal stability, divalent elements selected from the group consisting of Co, Zn, Ni, and Cu are desirable. From the perspective of enhancing output, Zn is desirable, and the exclusive use of Zn is preferred. However, even when exclusive substitution with divalent elements is conducted, when the content thereof is less than 0.5 atomic percent relative to 100 percent of the Fe content, the effect based on exclusive substitution with divalent elements tends not to be achieved. Additionally, When 5.0 atomic percent is exceeded, it is possible to inhibit demagnetization due to thermal fluctuation but difficult to raise the SNR. That is thought to be because the divalent elements do not form a solid solution in their entirety, precipitating out. Accordingly, in the present invention, the content of divalent elements exclusively substituted for Fe is 0.5 to 5.0 atomic percent per 100 atomic percent of the Fe content. From the perspectives of enhancing the thermal stability and SNR, the content of the divalent elements desirably falls within a range of 1.0 to 4.0 atomic percent and preferably falls within a range of 1.5 to 3.5 atomic percent.

In the present invention, the content of each element in the hexagonal ferrite magnetic particles can be determined by a known elemental analysis method such as inductively coupled plasma (ICP) analysis. The hexagonal ferrite magnetic particles can be obtained by the glass crystallization method described further below. Since all or nearly 100 percent of the quantity of divalent elements charged in the glass crystallization method is present in the magnetic particles, it is also possible to calculate the content from the quantity charged.

The hexagonal ferrite magnetic particles constituting the magnetic recording powder of the present invention contain 0.5 to 5.0 atomic percent of divalent elements as Fe substitution elements per 100 atomic percent of the Fe content and have an activation volume falling within a range of 1,200 to 1,800 nm³. Microparticulate magnetic particles with the above activation volume make it possible to lower noise and achieve a high SNR in the high-density recording region. By contrast, when the activation volume exceeds 1,800 nm³, it becomes difficult to reproduce with high sensitivity a signal that has been recorded at high density (the SNR drops). Additionally, manufacturing is difficult with hexagonal ferrite magnetic particles with an activation volume of less than 1,200 nm³. Even when manufacturing is successful and the above prescribed quantity of divalent elements is exclusively substituted for Fe, it is difficult to enhance the thermal stability and there is a risk of loss of recording due to thermal fluctuation. Accordingly, from the perspectives of simultaneously achieving a high SNR and high thermal stability in the high-density recording region, the activation volume of the hexagonal ferrite magnetic particles is set to within a range of 1,200 to 1,800 nm³. The activation volume can be controlled by means of the magnetic particle manufacturing conditions. For example, when manufacturing is being conducted by the glass crystallization method, the activation volume of the magnetic particles can be controlled by means of the crystallization conditions.

It suffices for the hexagonal ferrite magnetic particles to contain 0.5 to 5.0 atomic percent of a divalent element as an Fe substitution element per 100 atomic percent of the Fe content and to have an activation volume falling within a range of 1,200 to 1,800 nm³. For example, they can be magnetoplumbite barium ferrite, magnetoplumbite ferrite with spinel-coated particle surfaces, and magnetoplumbite barium ferrite a portion of which contains spinel phase.

Since the hexagonal ferrite magnetic particles constituting the magnetic recording powder of the present invention as set forth above satisfy the above conditions, it is possible to raise the thermal stability without raising Ku and inviting a drop in recording suitability. Thus, it is possible to achieve both high thermal stability and good recording suitability (ease of writing). As set forth above, it is presumed that the exclusive substitution of a prescribed quantity of divalent elements into these hexagonal ferrite magnetic particles contributes to markedly increasing the thermal stability (resistance to change in temperature) of the coercive force. Fluctuation of the coercive force over a prescribed temperature range can be employed as an index of the thermal stability of coercive force. Based on the present invention, it is possible to achieve a thermal stability of fluctuation in coercive force over a range of −190° C. to 25° C. of equal to or lower than 35.0 percent—for example, a range of 15.0 to 30.0 percent—in the hexagonal ferrite magnetic particles. Generally, thermal fluctuation in coercive force is greatly affected by particle volume, and it is difficult to obtain the thermal stability that can be achieved by the present invention in hexagonal ferrite magnetic particles with an activation volume of 1,200 to 1,800 nm³ without the exclusive substitution of divalent elements. The above fluctuation in coercive force is a value that is measured by the method described in Examples further below. From the perspective of achieving a high SNR, the coercive force Hc desirably falls within a range of 140 to 320 kA/m. The saturation magnetization σs of the magnetic recording powder of the present invention can be, for example, equal to or greater than 30 A·m²/kg, and is desirably equal to or greater than 40 A·m²/kg. From the perspectives of controlling the noise accompanying the reproduced signal and saturation of the GMR reproduction head, it is generally thought sufficient for σs to not be excessively high. From this perspective, the upper limit of σs can be about 60 A·m²/kg. However, from the perspectives of recording characteristics and reproduction output, a high σs is desirable. Accordingly, magnetic particles having a relatively high σs in which the generation of noise and head saturation are controlled by system optimization and the like can be employed to further enhance recording characteristics and reproduction output.

The method of manufacturing the above magnetic recording powder of the present invention is not specifically limited. A known barium ferrite magnetic powder manufacturing method can be employed to manufacture the magnetic recording powder of the present invention, such as the glass crystallization method, the hydrothermal synthesis method, and the coprecipitation method. Use of the glass crystallization method is desirable for readily obtaining the above microparticulate magnetic particles.

That is, the present invention relates to a method of manufacturing the magnetic recording powder of the present invention (also referred to as simply the “method of manufacturing magnetic powder”, hereinafter) by the glass crystallization method.

The method of manufacturing the magnetic powder of the present invention conducts a glass crystallization method employing a mixture of starting materials comprising just a divalent element component as an Fe substitution component in which the divalent element content ranges from 0.5 to 5.0 atomic percent relative to 100 atomic percent of a content of Fe to yield magnetic recording powder comprising hexagonal ferrite magnetic particles, wherein the hexagonal ferrite magnetic particle comprises 0.5 to 5.0 atomic percent of an Fe substitution element in the form of just a divalent element per 100 atomic percent of a content of Fe and has an activation volume ranging from 1,200 to 1,800 nm³.

As set forth above, it is possible to obtain hexagonal ferrite incorporating all or nearly 100 percent of the divalent elements that are prepared as starting materials in the glass crystallization method. Thus, using the above mixture of starting materials makes it possible to obtain hexagonal ferrite magnetic particles containing just a divalent element component as an Fe substitution component and in which the content of a divalent element ranges from 0.5 to 5.0 atomic percent relative to 100 atomic percent of the Fe content. It is possible to keep the activation volume thereof to within a range of 1,200 to 1,800 nm³ by means of the crystallization conditions. A more detailed description will be given further below.

The method of manufacturing magnetic powder of the present invention yields hexagonal ferrite magnetic particles by the glass crystallization method as set forth above. The glass crystallization method generally comprises the following steps:
(1) a step of obtaining a melt by melting a starting material mixture comprising a glass-forming component and a hexagonal ferrite-forming component (melting step);
(2) a step of quenching the melt to obtain an amorphous material (amorphous rendering step);
(3) a step of heat treatment of the amorphous material to induce the precipitation of hexagonal ferrite particles (crystallization step); and
(4) a step of collecting the hexagonal ferrite magnetic particles that have precipitated from the heat treated material (particle collecting step).

Here, in the method of manufacturing magnetic powder of the present invention, the above mixture of starting materials is employed as the starting material mixture in step (1). Subsequently, in steps (2) and (3), hexagonal ferrite magnetic particles can be caused to precipitate along with crystallized glass components. Subsequently, in step (4), an acid treatment and washing treatment are conducted to collect hexagonal ferrite magnetic particles. Thus, hexagonal ferrite magnetic particles containing just a divalent element as an Fe substitution element in which the content of divalent elements ranges from 0.5 to 5.0 atomic percent relative to 100 atomic percent of the Fe content and the activation volume falls within a range of 1,200 to 1,800 nm³ can be manufactured by a glass crystallization method employing a mixture of starting materials containing just a divalent element component as an Fe substitution component in which the divalent element content ranges from 0.5 to 5.0 atomic percent relative to 100 atomic percent of the Fe content.

The method of manufacturing magnetic powder of the present invention will be described with greater specificity below.

(1) Melting Step

The starting material mixture employed in the glass crystallization method contains a glass-forming component and a hexagonal ferrite-forming component. The term “glass-forming component” refers to a component that is capable of exhibiting a glass transition phenomenon to form an amorphous material (vitrify). A B₂O₃ component is normally employed as a glass-forming component in the glass crystallization method. In the present invention, it is possible to employ a starting material mixture containing a B₂O₃ component as the glass-forming component. In the glass crystallization method, the various components contained in the starting material mixture are present in the form of oxides or various salts that can be converted to oxides in a step such as melting. In the present invention, the term “B₂O₃ component” includes B₂O₃ itself and various salts, such as H₃BO₃, that can be changed into B₂O₃ in the process. The same holds true for other components. Examples of glass-forming components other than B₂O₃ components are SiO₂ components, P₂O₅ components, and GeO₂ components. Al can be added in the form of oxides or various salts (such as hydroxides) that can be converted to oxides in a step such as melting

Metal oxides such as Fe₂O₃, BaO, SrO, and PbO are examples of hexagonal ferrite magnetic powder structural components serving as the hexagonal ferrite-forming components contained in the above mixture of starting materials. For example, by employing Fe₂O₃ and BaO as the main hexagonal ferrite-forming components, it is possible to obtain barium ferrite magnetic particles. In the method of manufacturing magnetic powder of the present invention, a mixture of starting materials containing just a divalent element component as an Fe substitution component is employed as the hexagonal ferrite-forming components. The oxides of divalent elements or various salts (hydroxides and the like) that are capable of converting to oxides in a melting step or the like can be employed as the divalent element components. As set forth above, hexagonal ferrite incorporating all or nearly 100 percent of the divalent elements prepared as starting materials is obtained by the glass crystallization method. Thus, by employing a mixture of starting materials in which the content of divalent elements is 0.5 to 5.0 atomic percent per 100 atomic percent of the Fe content, it is possible to obtain hexagonal ferrite magnetic particles in which a desired quantity of divalent elements has been substituted for Fe.

In this context, the term “Fe substitution component” refers to a component containing an element substituting for Fe (trivalent iron) in the crystalline structure of the hexagonal ferrite magnetic particle. As set forth above, the common glass crystallization method is widely conducted by substituting other elements for a portion of the Fe³⁺. In that case, charge compensation (valence compensation) is conducted to render the total charge of the substitution elements equal to the charge of the iron atoms that have been replaced. Accordingly, in the conventional glass crystallization method, divalent elements alone are not substituted for a portion of the Fe in the manner of the present invention. By contrast, in the present invention, a prescribed quantity of just a divalent element is substituted for a portion of the Fe without consideration of the charge balance. That makes it possible to increase the thermal stability without increasing anisotropy constant Ku in the microparticulate (having an activation volume of 1,200 to 1,800 nm³) hexagonal ferrite magnetic particles. Thus, it is possible to achieve both high thermal stability and good recording suitability.

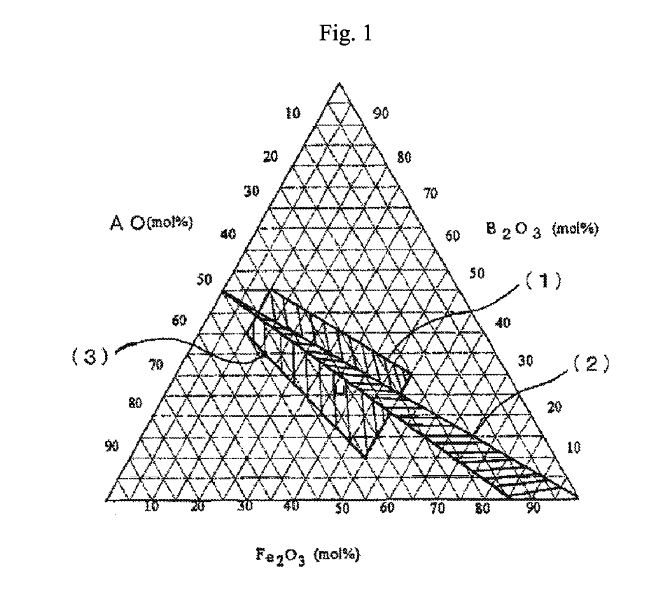

The composition of the starting material mixture is not specifically limited other than that the above prescribed quantity of just a divalent element component be contained as an Fe substitution component. In the method of manufacturing magnetic powder of the present invention, the composition of the mixture of starting materials is desirably determined to obtain magnetic particles with good magnetic characteristics from starting materials within the composition regions of hatched portions (1) to (3) in the triangular phase diagram shown in FIG. 1 which have vertices in the form of an AO component (in the formula, A denotes Ba, Sr, Pb, or the like), a B₂O₃ component, and an Fe₂O₃ component. In the method of manufacturing the magnetic powder of the present invention as set forth above, a divalent element component is substituted for a portion of the Fe₂O₃ component.

The above starting material mixture can be obtained by weighing out and mixing the various components. Then, the starting material mixture is melted in a melting vat to obtain a melt. The melting temperature can be set based on the starting material composition, normally, to 1,000 to 1,500° C. The melting time can be suitably set for suitable melting of the starting material mixture.

(2) Amorphous Rendering Step

Next, the melt that is obtained is quenched to obtain a solid. The solid is an amorphous material in the form of glass-forming components that have been rendered amorphous (vitrified). The quenching can be carried out in the same manner as in the quenching step commonly employed to obtain an amorphous material in glass crystallization methods. For example, a known method can be conducted, such as a quenching rolling method in which the melt is poured onto a pair of water-cooling rollers being rotated at high speed.

(3) Crystallization Step

Following the above quenching, the amorphous product obtained is heat treated. This step can cause hexagonal barium ferrite magnetic particles and crystallized glass components to precipitate. The size of the precipitating hexagonal barium ferrite magnetic particles can be controlled by means of the crystallization temperature and the period of heating during crystallization. In the pulverization treatment and dispersion treatment of the coating liquid, described further below, the size of the hexagonal barium ferrite magnetic particles does not change. Accordingly, the crystallization temperature and heating period are desirably determined to ultimately yield hexagonal barium ferrite magnetic particles having an activation volume of 1,200 to 1,800 nm³ in the present invention. The crystallization temperature also depends on the starting material composition, and it is desirably equal to or higher than 600° C. and equal to or lower than 750° C. The period of heating during crystallization (the period for which the crystallization temperature is maintained) is, for example, 0.1 to 24 hours, desirably 0.15 to 8 hours. The rate of rise in temperature up to the crystallization temperature is suitably about 0.2 to 10° C./minute, for example.

(4) Particle Collecting Step

Hexagonal barium ferrite magnetic particles and crystallized glass components precipitate out into the product that is subjected to the heat treatment in the crystallization step. Accordingly, when the heat treated product is subjected to an acid treatment, the crystallized glass components surrounding the particles are dissolved away, and the hexagonal barium ferrite magnetic particles can be collected.

Prior to the acid treatment, it is desirable to conduct a pulverization treatment to increase the efficiency of the acid treatment. Crude pulverization can be conducted by either a wet or dry method. From the perspective of achieving uniform powder pulverization, it is desirable to conduct wet pulverization. The pulverization treatment conditions can be set according to a known method. Reference can be made to Examples set forth further below. The acid treatment to collect the particles can be conducted according to a method generally employed in the glass crystallization method, such as an acid treatment with heating. Reference can also be made to Examples set forth further below. Subsequently, as needed, post-processing such as water washing and drying can be conducted to obtain hexagonal ferrite magnetic particles containing 0.5 to 5.0 atomic percent of just a divalent element as an Fe substitution element relative to 100 atomic percent of the Fe content and having an activation volume falling within a range of 1,200 to 1,800 nm³.

The magnetic recording medium of the present invention, comprising a magnetic layer containing ferromagnetic powder and a binder on a nonmagnetic support, comprises the magnetic recording powder of the present invention as the ferromagnetic powder. As set forth above, the magnetic recording powder of the present invention can exhibit the three characteristics of high-density recording, thermal stability, and ease of writing; resolve the above trilemma; and permit further advances in high-density recording.

The magnetic recording medium of the present invention will be described in greater detail below.

Magnetic Layer

Details of the ferromagnetic powder employed in the magnetic layer, and the method of manufacturing the powder, are as set forth above. In addition to the magnetic powder, the magnetic layer comprises a binder. Examples of the binder comprised in the magnetic layer are: polyurethane resins; polyester resins; polyamide resins; vinyl chloride resins; styrene; acrylonitrile; methyl methacrylate and other copolymerized acrylic resins; nitrocellulose and other cellulose resins; epoxy resins; phenoxy resins; and polyvinyl acetal, polyvinyl butyral, and other polyvinyl alkyral resins. These may be employed singly or in combinations of two or more. Of these, the desirable binders are the polyurethane resins, acrylic resins, cellulose resins, and vinyl chloride resins. These resins may also be employed as binders in the nonmagnetic layer described further below. Reference can be made to paragraphs [0029] to [0031] in Japanese Unexamined Patent Publication (KOKAI) No. 2010-24113, which is expressly incorporated herein by reference in its entirety, for details of the binder. A polyisocyanate curing agent may also be employed with the above resins.

As needed, additives can be added to the magnetic layer. Based on the properties desired, suitable quantities of abrasives, lubricating agents, dispersing agents, dispersion adjuvants, antifungal agents, antistatic agents, oxidation inhibitors, solvents, and carbon black can be suitably selected from among commercial products and products prepared by known methods for use as additives. Reference can be made to paragraph [0033] of Japanese Unexamined Patent Publication (KOKAI) No. 2010-24113 with regard to carbon black.

Nonmagnetic Layer

Details of the nonmagnetic layer will be described below. The magnetic recording medium of the present invention may comprise a nonmagnetic layer comprising a nonmagnetic powder and a binder between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides. These nonmagnetic powders are commercially available and can be manufactured by the known methods. Reference can be made to paragraphs [0036] to [0039] in Japanese Unexamined Patent Publication (KOKAI) No. 2010-24113 for details thereof.

Binder resins, lubricants, dispersing agents, additives, solvents, dispersion methods, and the like suited to the magnetic layer may be adopted to the nonmagnetic layer. In particular, known techniques for the quantity and type of binder resin and the quantity and type of additives and dispersing agents employed in the magnetic layer may be adopted thereto. Carbon black and organic powders can be added to the magnetic layer. Reference can be made to paragraphs [0040] to [0042] in Japanese Unexamined Patent Publication (KOKAI) No. 2010-24113 for details thereof.

Nonmagnetic Support

A known film such as biaxially-oriented polyethylene terephthalate, polyethylene naphthalate, polyamide, polyamidoimide, or aromatic polyamide can be employed as the nonmagnetic support. Of these, polyethylene terephthalate, polyethylene naphthalate, and polyamide are preferred.

These supports can be corona discharge treated, plasma treated, treated to facilitate adhesion, heat treated, or the like in advance. The center average roughness, Ra, at a cutoff value of 0.25 mm of the nonmagnetic support suitable for use in the present invention preferably ranges from 3 to 10 nm.

Layer Structure

As for the thickness structure of the magnetic recording medium of the present invention, the thickness of the nonmagnetic support preferably ranges from 3 to 80 ₗam. The thickness of the magnetic layer can be optimized based on the saturation magnetization of the magnetic head employed, the length of the head gap, and the recording signal band, and is normally 10 to 150 nm, preferably 20 to 120 nm, and more preferably, 30 to 100 nm. At least one magnetic layer is sufficient. The magnetic layer may be divided into two or more layers having different magnetic characteristics, and a known configuration relating to multilayered magnetic layer may be applied.

The nonmagnetic layer is, for example, 0.1 to 3.0 μm, preferably 0.3 to 2.0 μm, and more preferably, 0.5 to 1.5 μm in thickness. The nonmagnetic layer of the magnetic recording medium of the present invention can exhibit its effect so long as it is substantially nonmagnetic. It can exhibit the effect of the present invention, and can be deemed to have essentially the same structure as the magnetic recording medium of the present invention, for example, even when impurities are contained or a small quantity of magnetic material is intentionally incorporated. The term “essentially the same” means that the residual magnetic flux density of the nonmagnetic layer is equal to or lower than 10 mT, or the coercive force is equal to or lower than 7.96 kA/m (equal to or lower than 100 Oe), with desirably no residual magnetic flux density or coercive force being present.

Backcoat Layer

A backcoat layer can be provided on the surface of the nonmagnetic support opposite to the surface on which the magnetic layer are provided, in the magnetic recording medium of the present invention. The backcoat layer desirably comprises carbon black and inorganic powder. The formula of the magnetic layer or nonmagnetic layer can be applied to the binder and various additives for the formation of the back layer. The back layer is preferably equal to or less than 0.9 μm, more preferably 0.1 to 0.7 μm, in thickness.

Manufacturing Method

The process for manufacturing magnetic layer, nonmagnetic layer and backcoat layer coating liquids normally comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the magnetic layer, nonmagnetic layer and backcoat layer coating liquids. Dispersing media with a high specific gravity such as zirconia beads, titania beads, and steel beads are also suitable for use. The particle diameter and filling rate of these dispersing media can be optimized for use. A known dispersing device may be employed. Reference can be made to paragraphs [0051] to [0052] in Japanese Unexamined Patent Publication (KOKAI) No. 2010-24113 for details of the method of manufacturing a magnetic recording medium.

By containing the magnetic recording powder of the present invention, the magnetic recording medium of the present invention can achieve a high reproduction output and a high SNR in the high-density recording region. Thus, it is suitable as a high-density recording-use magnetic recording medium of which good electromagnetic characteristics are required.

### EXAMPLES

The present invention will be described in detail below based on Examples. However, the present invention is not limited to Examples. The terms “parts” and “percent” given in Examples are weight parts and weight percent unless specifically stated otherwise.

1. Preparation of the Magnetic Recording Powder (Hexagonal Ferrite Magnetic Particles)

A starting material formula was determined to obtain the composition of Table 1 with a total quantity of starting materials of 2 kg based on a starting material composition of 35.2 mol % BaO, 29.4 mol % B₂O₃, and 35.4 mol % Fe₂O₃, employing divalent element and pentavalent oxides as components to be substituted for a portion of the Fe, and employing SiO₂ and Al₂O₃ as components to be substituted for a portion of the B₂O₃.

The various components were weighed out in quantities yielding the starting material formula that had been determined and mixed in a mixer to obtain a starting material mixture. The starting material mixture obtained was melted in a 1 L platinum crucible. An outlet positioned on the bottom of the platinum crucible was heated while stirring at 1,380° C. and the melt was discharged in rod form at about 6 g/s. The discharge liquid was quench rolled with two water-cooled rolls to prepare amorphous products A to N.

A 300 g quantity of each of the amorphous products obtained was charged to an electric furnace, heated at 3.5° C./minute to the crystallization temperature indicated in Table 2, and maintained for the period indicated in Table 2 (“Crystallization Period” in Table 2) at the crystallization temperature to cause hexagonal barium ferrite magnetic particles to precipitate (crystallize). Next, the crystallized product containing the hexagonal barium ferrite magnetic particles was coarsely pulverized in a mortar, 1,000 g of Zr beads 1 mm in diameter and 800 mL of a 1% concentration of acetic acid were added to a 2,000 mL glass flask, and the mixture was dispersed for 3 hours in a paint shaker. The dispersion was separated from the beads and charged to a 3 L stainless steel beaker. The dispersion was treated for 3 hours at 100° C., precipitated in a centrifugal separator, repeatedly washed by decantation, and dried, yielding magnetic particles (Nos. 1 to 18). The magnetic particles obtained were analyzed by X-ray diffraction to confirm that they were hexagonal ferrite (barium ferrite).

2. Preparation of Magnetic Recording Medium (Magnetic Tape)

2-1. Formula of magnetic layer coating liquid

| | | |
|---|---|---|
| Hexagonal barium ferrite magnetic particles (indicated in | 100 | parts |
| Table 3): | | |
| Polyurethane resin: | 12 | parts |
| Weight average molecular weight: 10,000 | | |
| Sulfonic acid functional group content: 0.5 meq/g | | |
| Diamond microparticles (average particle diameter: 50 nm): | 2 | parts |
| Carbon black (made by Asahi Carbon, #55, particle size | 0.5 | part |
| 0.015 μm): | | |
| Stearic acid: | 0.5 | part |
| Butyl stearate: | 2 | parts |
| Methyl ethyl ketone: | 180 | parts |
| Cyclohexanone: | 100 | parts |

2-2. Nonmagnetic layer coating liquid

| | | |
|---|---|---|
| Nonmagnetic powder α-iron oxide: | 100 | parts |
| Average primary particle diameter: 0.09 μm | | |
| Specific surface area by BET method: 50 m²/g | | |
| pH: 7 | | |
| DBP oil absorption capacity: 27 to 38 g/100 g | | |
| Surface treatment agent Al₂O₃ 8 weight percent | | |
| Carbon black (made by Colombian Carbon, Conductex | 25 | parts |
| SC-U): | | |
| Vinyl chloride copolymer (made by Zeon Corp., MR 104): | 13 | parts |
| Polyurethane resin (made by Toyobo, UR8200): | 5 | parts |
| Phenyl phosphonic acid: | 3.5 | parts |
| Butyl stearate: | 1 | part |
| Stearic acid: | 2 | parts |
| Methyl ethyl ketone: | 205 | parts |
| Cyclohexanone: | 135 | parts |

2-3. Preparation of Magnetic Tape

The various components of each of the above coating liquids were kneaded in a kneader. The liquid was passed with a pump through a horizontal sand mill to which had been charged zirconia beads 1.0 mm in diameter in a 65 percent fill quantity based on the volume of the dispersing portion, and dispersion was conducted at 2,000 rpm for 120 minutes (the actual residence time of the dispersing portion). To the dispersion obtained were added 6.5 parts of polyisocyanate in the case of the nonmagnetic layer coating liquid, followed by 7 parts of methyl ethyl ketone. The mixture was filtered with a filter having an average pore diameter of 1 μm to prepare a nonmagnetic layer-forming coating liquid and a magnetic layer-forming coating liquid.

The nonmagnetic layer coating liquid obtained was coated and dried on a 5 μm polyethylene naphthalate base to a thickness of 1.0 μm, after which the magnetic layer was applied in a quantity calculated to yield a dry thickness of 70 nm in a sequential multilayer coating. Following drying, the product was processed at a linear pressure of 300 kg/cm at a temperature of 90° C. in a seven-stage calender. The product was slit to a width of ¼ inch and subjected to a surface abrasion treatment to obtain magnetic tapes (Nos. 1 to 18).

3. Evaluation of the Magnetic Particles and Magnetic Tapes

The magnetic particles and magnetic tapes were evaluated by the following methods. In the various evaluations, measurements were made in a 23° C.±1° C. environment.
(1) Magnetic Characteristics (Hc, σs)

The magnetic characteristics of magnetic particle Nos. 1 to 18 in Table 1 were measured with a vibrating sample fluxmeter (made by Toei Industry Co., Ltd.) at a magnetic field intensity of 1,194 kA/m (15 kOe).
(2) Output, Noise, and SNR

The reproduction output, noise, and SNR of each of magnetic tape Nos. 1 to 18 in Table 3 were measured after mounting a recording head (MIG, gap 0.15 μm, 1.8 T) and a reproduction GMR head on a drum tester and recording a signal at a track density of 16 KTPI and at a linear recording density of 400 Kbpi (surface recording density 6.4 Gbpsi).
(3) Demagnetization

Magnetic tape Nos. 1 to 18 in Table 3 were saturation magnetized at 1,194 kA/m (15 kOe) with a vibrating sample fluxmeter (made by Toei Industry Co., Ltd.), the field polarity was changed, a reverse field of 500 Oe was applied, and the demagnetization was calculated from the level of magnetization at 0 s and the level of magnetization at 60 s.

Demagnetization (%)=1−(level of magnetization at 60 s/level of magnetization at 0 s)×100
(4) Activation Volume V, Anisotropy Constant Ku, KuV/kT

Using a vibrating sample fluxmeter (made by Toei Industry Co., Ltd.), measurement was conducted with Hc measurement portion field sweep speeds of 3 minutes and 30 minutes. The activation volume V and the anisotropy constant Ku were calculated based on the relational equation of Hc due to thermal fluctuation and the volume magnetization reversal, as described below. KuV/kT was then calculated from the values obtained.

Hc=2Ku/Ms (1−((KuT/kV)ln(At/0.693))½)

(In the equation, Ku: anisotropy constant; Ms: saturation magnetization; k: Boltzmann constant; T: absolute temperature; V: activation volume; A: spin precession frequency; and t: field reversal time.)

Table 1 gives details of the starting material formulas of the magnetic particles described above. Table 2 gives the crystallization temperatures during magnetic particle preparation and the results of evaluation of the magnetic particles prepared. Table 3 gives the details of the magnetic tapes prepared.

TABLE 1

| | | Quantity | | Quantity | |
|---|---|---|---|---|---|
| | | of substi- | | of substi- | |
| Amorphous | | tution | Penta- | tution | Substance |
| product | Divalent | atomic % | valent | atomic % | added* |
| No | element | (per Fe) | element | (per Fe) | mol % |
| A | Zn | 2.0 | Nb | 1.0 | — |
| B | Zn | 0.3 | — | 0 | — |
| C | Zn | 0.5 | — | 0 | — |
| D | Zn | 1.5 | — | 0 | — |
| E | Zn | 3.0 | — | 0 | — |
| F | Zn | 5.0 | — | 0 | — |
| G | Zn | 5.2 | — | 0 | — |
| H | Zn | 3.0 | — | 0 | Al₂O₃ 5% |
| I | Zn | 3.0 | — | 0 | SiO₂ 5% |
| J | Co | 3.0 | — | 0 | — |
| K | — | — | Nb | 3.0 | — |
| L | Ni | 3.0 | — | 0 | — |
| M | Cu | 3.0 | — | 0 | — |
| N | Zn + Co | 1.5 + 1.5 | — | 0 | — |

*The substance was added by replacing a portgion of starting material B₂O_{3.}

TABLE 2

| Magnetic | Aporphous | Crystallization | Period of heating | | | | |
|---|---|---|---|---|---|---|---|
| material | material | temp. | during crystallization | Vact | σs | Hc | |
| No | No | ° C. | H | nm³ | A · m²/Kg | KA/m | KuV/kT |
| 1 | A | 600 | 5.00 | 1320 | 40 | 129 | 50 |
| 2 | A | 610 | 5.00 | 1580 | 46 | 170 | 58 |
| 3 | A | 640 | 5.00 | 1900 | 55 | 213 | 69 |
| 4 | E | 605 | 0.67 | 1200 | 40 | 148 | 50 |
| 5 | E | 620 | 5.00 | 1590 | 47 | 211 | 57 |
| 6 | E | 650 | 5.00 | 1820 | 55 | 230 | 68 |
| 7 | B | 630 | 0.17 | 1510 | 43 | 255 | 53 |
| 8 | C | 630 | 0.17 | 1520 | 45 | 239 | 51 |
| 9 | D | 610 | 5.00 | 1610 | 42 | 206 | 61 |
| 10 | F | 630 | 0.17 | 1500 | 43 | 151 | 52 |
| 11 | G | 630 | 0.17 | 1540 | 40 | 147 | 47 |
| 12 | H | 645 | 0.17 | 1500 | 51 | 172 | 53 |
| 13 | I | 645 | 0.17 | 1510 | 48 | 154 | 53 |
| 14 | J | 620 | 5.00 | 1600 | 42 | 182 | 61 |
| 15 | K | 680 | 5.00 | 1630 | 51 | 173 | 59 |
| 16 | L | 635 | 1.00 | 1600 | 46 | 199 | 59 |
| 17 | M | 635 | 0.17 | 1720 | 46 | 228 | 65 |
| 18 | N | 620 | 5.00 | 1610 | 45 | 200 | 60 |

TABLE 3

| | | Magnetic | | | | |
|---|---|---|---|---|---|---|
| Medium | | powder | Output | Noise | SNR | Demagne- |
| No | | No | dB | dB | dB | tization % |
| 1 | Comp Ex. | 1 | −2.1 | −3.3 | 1.2 | 21 |
| 2 | Comp Ex. | 2 | 0 | 0 | 0 | 14 |
| 3 | Comp. Ex. | 3 | 0.9 | 1.9 | −1.0 | 3 |
| 4 | Ex. | 4 | −2.7 | −3.8 | 1.1 | 8 |
| 5 | Ex. | 5 | −1.7 | −3.5 | 1.8 | 5 |
| 6 | Comp. Ex. | 6 | 1.1 | 1.5 | −0.4 | 2 |
| 7 | Comp Ex. | 7 | −1.6 | −3.3 | 1.7 | 13 |
| 8 | Ex. | 8 | −1.5 | −3.2 | 1.7 | 6 |
| 9 | Ex. | 9 | −0.5 | −2.5 | 2.0 | 3 |
| 10 | Ex. | 10 | −1.3 | −2.3 | 1.0 | 2 |
| 11 | Comp Ex. | 11 | −2.0 | −2.2 | 0.2 | 2 |
| 12 | Ex. | 12 | −0.5 | −1.9 | 1.4 | 3 |
| 13 | Ex. | 13 | −0.7 | −2.0 | 1.3 | 2 |
| 14 | Ex. | 14 | −0.4 | −1.8 | 1.4 | 3 |
| 15 | Comp Ex. | 15 | −0.2 | −2.1 | 1.9 | 17 |
| 16 | Ex. | 16 | −0.4 | −2 | 1.6 | 3 |
| 17 | Ex. | 17 | 0.6 | −0.9 | 1.5 | 3 |
| 18 | Ex. | 18 | −0.3 | −1.9 | 1.6 | 2 |

As indicated in Table 3, the magnetic tapes of Examples exhibited little demagnetization and a high SNR. Thus, the fact that high thermal stability (low demagnetization) was achieved in the high-density recording region when employing microparticulate magnetic powder with an activation volume of 1,200 to 1,800 nm³ was confirmed. Based on the values of KuV/kT of the magnetic powders shown in Table 2, this thermal stability was achieved without an increase in Ku that would lower the ease of writing.

By contrast, based on the results in the comparative examples, the fact that thermal stability could not be enhanced unless Fe was replaced with just divalent elements (media Nos. 1, 2 and 15); the fact that thermal stability could not be enhanced if the quantity of divalent elements substituted for Fe was too small (medium No. 7), the fact that the SNR tended to drop when this quantity was excessive (medium No. 11), and the fact that an enhanced SNR could not be achieved with coarse particles with an activation volume exceeding 1,800 nm³ (media Nos. 3 and 6) were confirmed.

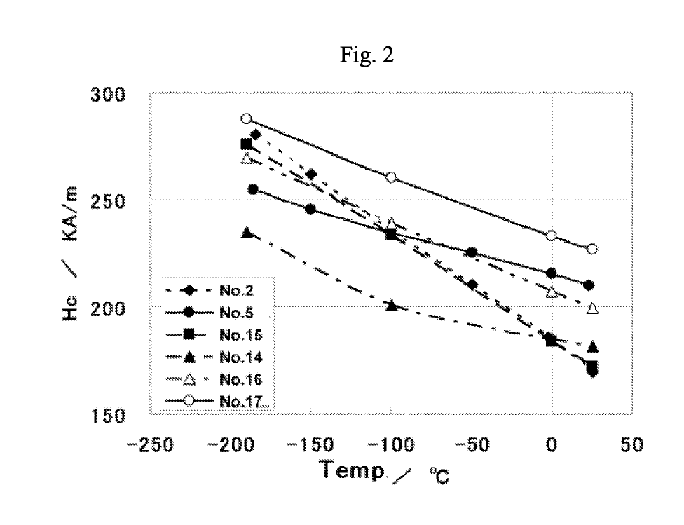

FIG. 2 shows a graph of the results of the evaluation of the temperature dependence of Hc at −190° C. to +25° C. based on the following measurement method for the following Examples and comparative examples:
Magnetic powder No. 2 (a comparative example in which divalent and pentavalent elements were substituted for Fe: 2 atomic percent of Zn and 1 atomic percent of Nb for substitution of Fe)
Magnetic powder No. 15 (a comparative example in which a pentavalent element was substituted for Fe: 3 atomic percent of Nb for substitution of Fe)
Magnetic powder No. 5 (Example: 3 atomic percent of Zn for substitution of Fe)
Magnetic powder No. 14 (Example: 3 atomic percent of Co for substitution of Fe)
Magnetic powder No. 16 (Example: 3 atomic percent of Ni for substitution of Fe)
Magnetic powder No. 17 (Example: 3 atomic percent of Cu for substitution of Fe) shown in Table 2.

### Measurement Method

The various magnetic powders were packed into aluminum cells, and the Hc was measured over a temperature range of −190° C. to +25° C. under the same field intensity using the same device as in the above magnetic characteristic (Hc, σs) measurement methods while measuring the temperature of the magnetic powder with thermocouples positioned in proximity to the cells. In the measurement, the entire vibrating sample rod of the vibrating sample fluxmeter was positioned within a quartz tube, and while drawing a vacuum with a rotary pump, immersed in a Dewar bottle filled with liquid nitrogen. The temperature was controlled by running a current through an electric heater mounted on the quartz tube.

Based on the results in FIG. 2, the coercive force fluctuation over the range of −190° C. to +25° C. of the various magnetic powders was calculated from equation (1). The results are given in Table 4 below.

Coercive force fluctuation (%)=(1−(coercive force at +25° C.)/(coercive force at −190° C.))×100 (1)

TABLE 4

| Magnetic material | Coercive force fluctuation |
|---|---|
| No. 2 (Comp. Ex.: Zn—Nb substitution) | 39.5% |
| No. 15 (Comp. Ex.: Nb substitution) | 37.5% |
| No. 5 (Ex.: Zn substitution) | 17.6% |
| No. 14 (Ex.: Co substitution) | 22.8% |
| No. 16 (Ex.: Ni substitution) | 26.0% |
| No. 17 (Ex.: Cu substitution) | 21.1% |

As shown in Table 1, thermal stability in the form of a coercive force fluctuation of equal to or lower than 35.0% was obtained in the magnetic powders of Examples. Relative to the magnetic powders of the comparative examples, the Hc temperature dependence was determined to be markedly lower and the magnetic properties were determined to be highly stable. The present inventors thought that these characteristics might have affected on inhabitation of demagnetization due to thermal fluctuation.

Based on the results set forth above, the present invention showed that it was possible to obtain a magnetic recording medium satisfying the three characteristics of high density recording, thermal stability, and ease of writing. That is, the present invention can resolve the trilemma of magnetic recording.

The present invention can provide a high-density recording-use magnetic recording medium affording good recording and reproduction characteristics.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. Magnetic recording powder, which comprises hexagonal ferrite magnetic particles, the hexagonal ferrite magnetic particle comprising 0.5 to 5.0 atomic percent of an Fe substitution element in the form of just a divalent element per 100 atomic percent of a content of Fe and having an activation volume ranging from 1,200 to 1,800 nm³.

2. The magnetic recording powder according to claim 1, wherein the divalent element is selected from the group consisting of Co, Zn, Ni, and Cu.

3. The magnetic recording powder according to claim 1, wherein the divalent element comprises Zn.

4. The magnetic recording powder according to claim 1, wherein the divalent element is just Zn.

5. The magnetic recording powder according to claim 1, which has thermal stability in the form of a coercive force fluctuation calculated from equation (1) below being equal to or lower than 35.0% over a range of −190° C. to +25° C.:
Coercive force fluctuation (%)=(1−(coercive force at +25° C.)/(coercive force at −190° C.))×100 (1).

6. A method of manufacturing magnetic recording powder, which comprises:
conducting a glass crystallization method employing a mixture of starting materials comprising just a divalent element component as an Fe substitution component in which the divalent element content ranges from 0.5 to 5.0 atomic percent relative to 100 atomic percent of a content of Fe to yield magnetic recording powder comprising hexagonal ferrite magnetic particles, wherein
the hexagonal ferrite magnetic particle comprises 0.5 to 5.0 atomic percent of an Fe substitution element in the form of just a divalent element per 100 atomic percent of a content of Fe and has an activation volume ranging from 1,200 to 1,800 nm³.

7. The method of manufacturing magnetic recording powder according to claim 6, wherein the divalent element component is an oxide of a divalent element selected from the group consisting of Co, Zn, Ni, and Cu.

8. The method of manufacturing magnetic recording powder according to claim 6, wherein the divalent element component comprises an oxide of Zn.

9. The method of manufacturing magnetic recording powder according to claim 6, wherein the divalent element component is just an oxide of Zn.

10. A magnetic recording medium comprising a magnetic layer containing ferromagnetic powder and a binder on a nonmagnetic support, wherein
the ferromagnetic powder is magnetic recording powder which comprises hexagonal ferrite magnetic particles, and the hexagonal ferrite magnetic particle comprises 0.5 to 5.0 atomic percent of an Fe substitution element in the form of just a divalent element per 100 atomic percent of a content of Fe and has an activation volume ranging from 1,200 to 1,800 nm³.
